(19) United States
(12) Patent Application Publication
(10) Pub. No.: US 2014/0089228 A1
(43) Pub. Date: Mar. 27, 2014

(54) Investment Management System

(71) Applicant: Angelsoft LLC (dba Gust), New York, NY (US)

(72) Inventor: Gil Silberman, San Francisco, CA (US)

(73) Assignee: Angelsoft LLC (dba Gust), New York, NY (US)

(21) Appl. No.: 14/029,768

(22) Filed: Sep. 17, 2013

Related U.S. Application Data
(60) Provisional application No. 61/701,921, filed on Sep. 17, 2012.

(51) Int. Cl. G06Q 40/00

(52) U.S. Cl. CPC G06Q 40/06
USPC 705/36 R

(57) ABSTRACT

An investment management system includes aspects of a points based social network. The system assigns point values, badges, levels and statuses to investors. The system permits investors to create investment proposals for a particular investment target company, including an amount of money and other terms. The system can group compatible investment proposals together so that they can be presented to the target as a single, larger proposal. The system can permit target companies to see what investment offers are available on a given set of terms, and permit the target companies to alter proposed terms and see the effect such an alteration has on available investment offers.

### PRIORITY AND RELATED PATENTS

This application claims priority to U.S. Provisional patent application Ser. No. ______, entitled ______, filed on Sep. 17, 2012, the full disclosure of which is incorporated herein by reference in its entirety.

### BACKGROUND

With the popularization of so-called “crowdfunding,” the adoption of new securities regulations in the United States, and expanded awareness of the importance of early stage investment in private companies, investors are looking for more efficient, effective ways to discover and place investments in suitable target companies, and companies in turn are looking for better ways to connect and work with investors. This community seeks new tools that improve upon traditional methods used by companies to make securities offerings, by taking advantage of online software platforms, social networks, and other technological means for connecting people.

Social media networks like Facebook, Twitter and LinkedIn have created a computer environment in which users can be matched with other users for the purposes of networking and/or consuming or exchanging content. Application services such as FourSquare have created a rewards or point system sometimes described as “gamification” for tracking and incentivizing conduct within such a social media environment that is based in real life behavior, such as, in the case of FourSquare, checking in when present at a particular geographical location or landmarks. This information about who checks in where and how often can inform other users with whom FourSquare users might wish to connect.

Investors in businesses, large and small, are always looking to connect, both with co-investors (with whom to jointly make an offer to finance a target company) and with target companies in which to invest. Investors, and companies seeking investment wish to know more information about each other. A social networking system for businesses and investors, which allows businesses and investors to find one another based on common investment interests and information gleaned from real world activities would reduce information asymmetry and encourage investment.

### SUMMARY

The invention relates to features of an investment management system (“IMS”), by which the users of the system are potential investors in companies with which they are not necessarily already familiar. Actual or potential investment targets—companies seeking investment funds—would also use the service, or be alerted to the service and invited to participate after receiving interest from investor users. The IMS system facilitates introductions, networking, and discovery among investors, and between investors and target companies, in some aspects using the functionality of, or similar to, social networking services. Certain features rate, rank, award, incentivize, gather data about, and otherwise differentiate investors based on their observed in-application behavior (such as making investment offers (also described here as “bids” or “proposals”), completing investments, and the overall success how well an investor's pool of investments have performed), as well as reported off-application behavior (their reported investment history, their reputation or ranking on other services such as Klout or LinkedIn, their resume and background, etc.).

In one aspect of the invention, the system can optionally serve as a platform/marketplace by which potential investors make binding or nonbinding, firm or conditional investment offers to companies, aggregate offers from multiple investors into a single combined offering (sometimes described as a syndicate, or a subscription offer) to finance a company, present counter-offers and acceptances, bind the investors and the target company to complete the proposed investment transaction, obtain signatures on documents, to handle payments, escrows, and issuance of security, and interact with other platforms and services that provide some of the foregoing features, or that handle investor and company relations, stock and option plan maintenance, company information, securities offering, and other business services.

In another aspect of the invention, the functionality that permits multiple investment offers to be aggregated further allows both investors and target companies to evaluate “what-if” scenarios, formulate offers, and accept a funding offer as thus filtered, by adjusting the parameters for transaction terms they will accept. Throughout this description, the ability of investors to specify the terms of their investment offers, and the company's ability to set and test which of those terms they will accept, are described interchangeably as setting and adjusting the conditions, filters, parameters, or constraints, or terms, of the offers. The system described here collects all of the offers that one or more investor users have made to invest in a particular target company, aggregates those offers into a proposed aggregate subscription to purchase the company's securities, evaluates and resolves any differing offer terms to determine whether they are compatible or contradictory, and then presents an aggregate offer to the target company (which may or may not contain detail about the constituent individual offers that form the aggregate offer). An example of contradictory offers would be if one investor user offers to fund a company provided that the aggregate subscription is between $1 million and $2 million, and a second investor user's offer specifies an aggregate subscription requirement of between $500,000 and $800,000. In this example, the two offers are in conflict and cannot both be accepted. The target company may then accept or reject the aggregate offer, or by altering the filtering constraints, evaluate and accept a sub-group of the less than all of the offers. The invention may also facilitate exchange of due diligence information and documents, and interface or host an exchange for secondary sales of securities.

In one aspect of the invention, an investment management system including one or more servers is disclosed. The servers include an investor database comprising investor information, an investment target database comprising company information, machine executable instructions and a user interface for creating and storing investment proposals, the proposals comprising proposed investor identification information, proposed investment target information, and information corresponding to at least one term of the proposed investment, and machine executable instructions for combining two or more investment proposals into an aggregate investment offer.

In one aspect of the invention, the one or more servers further includes machine executable instructions whereby an investment target can input at least one acceptable term and determine how much money is available for investment. The determination of how much money is available for investment includes the step of comparing the acceptable term to the at least one term of investment of at least one investment proposal.

In one aspect of the invention, the one or more servers further includes machine executable instructions for at least one function from the group consisting of: awarding and displaying badges, assigning levels to investors, assigning status to investors.

In one aspect of the invention, the one or more servers further includes machine executable instructions for reporting historical investments.

In one aspect of the invention, the one or more servers further includes machine executable instructions for grouping a plurality of investment proposals together on the basis of the investment proposals having a common investment target company and compatible terms.

In one aspect of the invention, one or more servers further includes machine executable instructions for notifying a user who creates an investment proposal that other compatible investment proposals have been created.

This SUMMARY is provided to briefly identify some aspects of the present disclosure that are further described below in the DESCRIPTION. This SUMMARY is not intended to identify key or essential features of the present disclosure nor is it intended to limit the scope of any claims.

The term “aspects” is to be read as “at least one aspect”. The aspects described above and other aspects of the present disclosure described herein are illustrated by way of example(s) and not limited in the accompanying figures.

### BRIEF DESCRIPTION OF THE DRAWINGS

A more complete understanding of the present disclosure may be realized by reference to the accompanying figures in which:

FIG. 1 is a flow diagram of an investment proposal creation method in accordance with one aspect of the present invention.

FIG. 2 is a flow diagram of a target company investment query in accordance with one aspect of the present invention.

FIG. 3 is a flow diagram of an investor networking method in accordance with one aspect of the present invention.

FIG. 4 is a diagram displaying a general purpose computer on which the system and method of the present disclosure may be implemented according to an aspect of present disclosure.

### DESCRIPTION

An investment management system is an online platform that facilitates the discovery, due diligence, completing paperwork, transfer of funds, and otherwise placement of investment funding (equity or debt financing) in private companies. Investing typically includes equity investments, but could include debt, convertible debt, donations, or some typical “crowdfunding” methods like advance purchases or pre-orders.

In one embodiment, the investment management system described also includes means to make an investment offer, a statement by an investor user to a prospective target company of the terms on which that investor proposes to invest. An offer to invest might include a subscription, which is a binding agreement to invest if certain conditions are met, e.g. the raising of a threshold target amount, or the qualifications of other investors.

Investment targets are typically corporations or other business organizations that are seeking growth financing. In one aspect of the invention, an “Entitlement” is featured. An Entitlement is a rewards/status system, described more fully below.

In one aspect, certain investor users are entitled to do things that others are not, which can be based on factors that are either within the platform, outside the platform, or those which span both. These include: different levels or categories of users, achieving a status (platinum, preferred, etc.), a badge (for example, a “clean tech” badge for placing certain types of investment in the clean technology space, or a “repeat player” badge), a total number of points, or other recorded attributes (e.g. possession of a token or coupon, an invitation from another user, or an entitlement that has been purchased or exchanged).

In one aspect, the system also is an electronic host for investors. An investment management system facilitates completing investments in investment targets. An another aspect, completed investments are reported but not facilitated. Investors report all of their investments, which are tracked through an exchange/crowd funding portal or other external source. Users' investments can be tracked through an investors' club or organization that reports them to the operators of the system.

The IMS embodiment described can include a crowd funding portal, or can interface with one (e.g. via an API) to fulfill the investment, publicize the investment, or to scrape, gather, or harvest lists of companies in order to create online representations for target companies that the system's investor users can evaluate. Lists of companies may also be obtained from other sources, such as business directories, databases, user-supplied information, or companies that sign up as system users to create a company profile or claim a profile that has already been created for the company.

In one aspect of the invention, an investment subscription system is disclosed. Users can complete a survey in which investor users submit their background via a survey, or linking to their other accounts (e.g. bank, money management, Facebook, LinkedIn, college group), qualify as an investor (assert or prove that they are accredited, or for crowdfunding purposes, that they are sophisticated or have a certain income level), join a group or network on the system, or place a bid to invest in a target company. Bids may contain one or more of the following: How many shares will be purchased or how much money will be invested, starting or ending date for the offer, prices per share or valuation, various terms demanded applicable to the shares and share ownership (minimum, range, or exact), Board seats to be granted to investors, covenants of the company, representations and warranties made, voting arrangements, information rights, and protective provisions, all as such terms are generally understood in by practitioners of securities transactions.

In an aspect of the system that facilitates investment subscriptions, investors may include specific financial terms in their offers, including: minimum/maximum size of offering round, minimum or maximum price, amount invested by that particular investor, maximum amount to invest, discount demanded on investment price or convertible note conversion rate, or other so-called “sweetener” (vis-à-vis other investors), interest rate demanded (for convertible notes and other debt instruments), dividends demanded, conversion terms applicable to convertible notes and other convertible securities, duration (i.e. length or date of the term) of convertible notes, anti-dilution preferences (for example, full ratchet, weighted average, etc), liquidation preferences (percentage/multiplier), liquidation preference that changes over time, liquidation preferences that are participating, and other financial terms that can be quantified and described. Some of these may be specific numbers, while others can be minimums or maximums for the category. For example, an investor willing to accept non-participating preferred equity is assumed also be willing to accept participating preferred because it is considered better. An investor willing to pay $3 per share, absent a statement to the contrary in their offer, is presumed to be willing to pay $2.50 per share. Other times, users will check off a range of acceptable options when completing the offer. In one aspect of the invention, users can parameterize the investment offers. In one aspect of the invention, a person with special privileges (or system access), e.g. an administrator, creates a list or template of some basic terms for a specific offer, or for a default to use again. In one aspect, an administrator with special privileges (or system) creates a menu of choices from which investors may choose.

Target companies do not necessarily have to create accounts or otherwise participate in advance. They may receive unsolicited offers from investors placing bids. Investor users can make offers to companies that do not yet participate in the IMS. The individual offers may also not be revealed to the target company. Rather, an aggregate offer that satisfies the intersection of multiple investors' offering condition parameters may be shown instead, or the target company may simply be informed that the system has a funding offer for them and invited to join or inquire further. The target company, or its representatives, can interact with the system by specifying the conditions to which it is willing to agree, and may use the system to report and visualize the extent to which changes in particular filtering parameters will increase or decrease the size of the pool of available capital, or other attributes of that pool. By loosening or tightening various conditions, the target company (or the system) filters various offers in or out of the prospective aggregate subscription offer, thereby increasing or decreasing the total pool of money available. Target companies may also use this filtering aspect to optimize for certain traits they desire in their offering, e.g. the highest valuation of the company, the most sophisticated group of investors, investors who are from a close geographic region, investors with the best reputations or ranking in the system, those who the company already knows or does not know (via social network information), and so on.

In one aspect, investor users can create a tracking entry for each known investment target. The system can allow investor users to submit their own company profiles for investment targets, or it can obtain investment targets from outside sources of new companies e.g. corporation filings, Regulation D filings, venture news sources, anonymously reported companies, business directories or databases, or news of investments in a particular sector.

A company, when considering accepting an individual offer or aggregate of multiple offers, may change the filtering constraints (parameters) in order to filter investors in and out to put together a subscription syndicate. Some adjustments relate to the offer parameters, such as minimum investment size or other financial terms, e.g. the price per share, liquidation preference, etc. Some relate to choosing the investor make-up, such as accepting specific investors, the geographic region of investors, allowing only investment funds rather than individuals, accredited investors only, etc. Companies may choose to filter for only what they deem to be higher-quality or more desirable investors based, for example, on the rewards status described later (points, level, etc), based on having certain badges, or real-world characteristics such as being successful investors, having a high reputation value, having strong networks, and so on, all as measured by data maintained by the system.

In another aspect of the invention, the system can give special opportunities (“superpowers” or “power-ups”) to investor users with a certain entitlements. Superpowers can include access to elite level or nonpublic investments, ability to change a bid or bid again if excluded from an investment, ability to bid or subscribe last minute after a company is fully subscribed, or access to extra sweeteners to the investment such as warrant coverage, discount, a valuation cap, etc.

The owners of the system in accordance with one aspect of the present invention may collect a fee that is a percentage of invested funds placed, and give a rebate back to super-investors, or others for meeting behavioral targets. This can be used to incentivized desired investment behavior.

Another optional feature of the system is to handle offers and counteroffers. In a case where the target company finds the aggregate subscription offer unacceptable but would accept the investment if the terms were changed, the company may tell the system what its minimum acceptable terms are. If one or more investor users have already made standing offers that fit within the company's parameters, the system informs the company of how much money is available within those parameters and on what terms. If the company wishes to make a counter-offer to the investors, the system will then present the counter-offer to some or all of the investors to query whether they will revise their offers. Counter-offers may also be originated from investors in response to a company request, or by the system directed to either side of the transaction to see if the system can assemble a group of investors to make a viable aggregate investment offering.

In accordance with one aspect of the present invention, a reward, incentivization, and play system is disclosed. The IMS can reward actions and behaviors that its operators, users, or sponsors wish to encourage, either after the fact (an unexpected reward) or a goal or quest (series of steps) announced to participants in advance. Desirability of behaviors can be measured among other things in: profitability for the owner of the system, education of people about investing, attempt to become or discover super-investors (as described above, things such as being “smart” money, having made successful investments, being insiders with high network or reputation value), the value to target companies or perceived social good. For examples, points, badges, encouragement, recognition, badges, intrinsic and extrinsic awards, and other benefits may be awarded for investing often, investing a large amount in total, investing on a regular schedule, investing in diverse geographical regions or business sectors, a particular investor's first investment in a particular region, business sector or type of company, being the first overall or within a group of investors to do so, inviting or referring others to use the system, investing in a new country or other jurisdiction, investing far away from past investments, or investing multiple times in a comparable transaction.

The foregoing are but a small number of the possible behaviors that may be incentivized or rewarded by the system, as nearly any behavior that can be detected and quantified may be rewarded. In the art of “gamification”, rewards are given for taking specified in-application or real-world actions such as “checking in” at a particular location, purchasing a particular thing, or otherwise using the system. The rewards system disclosed here is comparably broad, but directed at rewarding investment-related behaviors that are practiced on the IMS.

This optional feature bases its rewards/points on making specified investment decisions (such as presenting investment offers, inquiring or learning more about a particular target company, closing an investment, or overall company portfolio activity or value) in a particular company at a particular time. Target companies in turn have various features (size, industry, leadership, location, success), as do the investment offerings and closed transaction (size, type of round, etc.). Investors may be rewarded for making offers or otherwise interacting with target companies having these features.

The IMS, in one aspect, may calculate the estimated portfolio values of various investor users to measure the success, ability, and status of those investor members. The system can optionally reveal, or hide, the various factors that are used to make the valuation. It can use different sources to create an estimate for the value of each security. Second Market, or other exchanges can be a source of valuation information, as may be a curation system or participation of experts or system users. If a funding is announced in the trade press, the system can guess or calculate the valuation at which it was done. The system can offer reports of option plan (409) valuations, publicly or privately stated. The system can offer Insider reports whereby company insiders or investors can anonymously (to the public) report what their company value is. The exact method of estimating the value of private company securities is not a necessary feature to the system described. Rather, in this aspect, the invention uses the valuation information, however it was obtained, to estimate and compare the aggregate performance of various member users' investment portfolios.

The system can also include an investment simulation (or game) whereby users are given imaginary money and allowed to engage in fictitious or hypothetical buying and selling. This is a parallel system by which people buy and sell securities, or engage in the IMS, with virtual currency, i.e. a currency that is of no value and is not exchangeable for any real good or service. However the amount can be limited and earned or given to the players, creating an in-game value even if there is no inherent value in the currency. In this aspect, investor users buying and selling private company stock on the system do create an implied exchange value for each of the companies, and can earn points and otherwise improve their reputation on the IMS through their success at this simulated investment activity. In turn, the current price of the securities in this simulated market can be used as one of the inputs to estimate the value of investors' real-world portfolio. For example, the fact that company X's stock is worth $Y in virtual currency can be evidence tending to suggest it is worth $Y in real dollars.

In one aspect, the system may also allow for actual exchanges of equities or debt instruments, and may also present the opinions of experts to perform valuations or research.

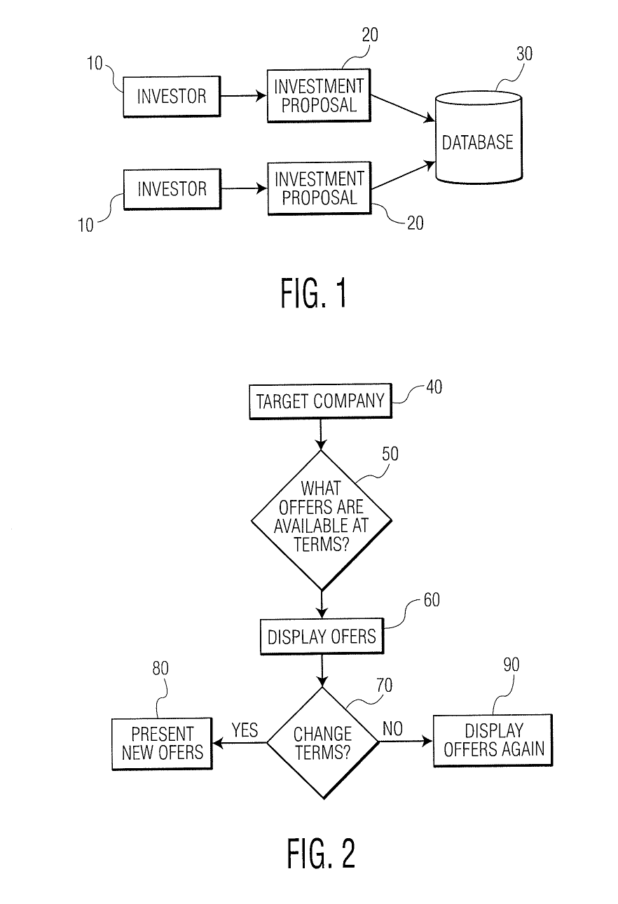

FIG. 1 is a flow diagram of an investment proposal creation method in accordance with one aspect of the present invention. Investor 10 creates an investment proposal 20 (described above as an offer). The investment proposal, as discussed, identifies the target investment company and the terms of the investment. The investment is stored in database 30. Additional investors 10 create additional investment proposals 20, to be stored in database 30, as shown.

FIG. 2 is a flow diagram of a target company investment query in accordance with one aspect of the present invention. Target company 40 queries the database to see which investment proposals are available given a defined set of parameter terms 50 (described above as filtering, or constraining, the aggregate investment offering). The aggregate offer, or individual offers that meet those constraints are displayed in step 60. If there are no filtering parameters specified, or if the filtering parameters are set broad enough, all of the offers will be presented, optionally creating a subset of offers that are mutually compatible and do not mutually conflict with one other. In step 70, the target company is given the opportunity to vary the terms it would accept. If it chooses to do so, then a new aggregate offer or list of individual investment proposals is presented, which is compatible with the newly entered terms. If it chooses not to do so, it is returned to the initial offers.

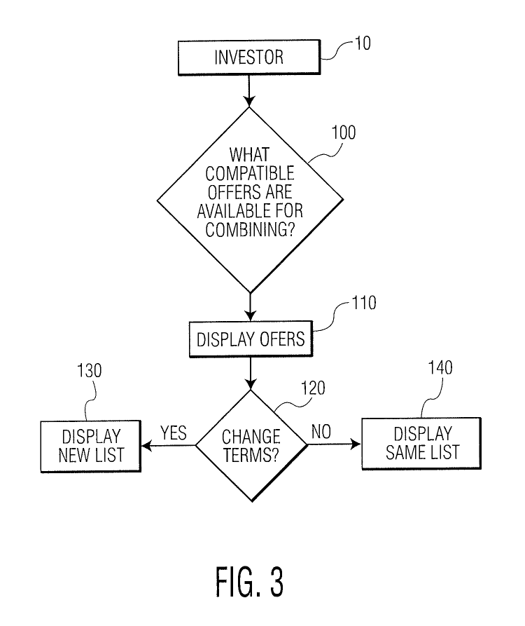

FIG. 3 is a flow diagram of an investor networking method in accordance with one aspect of the present invention. Investor 10 searches for other compatible investors 100. As discussed above, this groups investors who wish to invest in the same company together, if their required terms are compatible, for the purposes of presenting a larger offer to a target company (in alternate embodiments, a syndicate of multiple investors may be put together by the system even though those investors are not connected to each other or did not previously intend to act in collaboration). In step 110 the offers are displayed. In step 120, the company or investor is given the option of changing the acceptable terms. If that investor chooses to do so, then a new list of compatible investments is presented in step 130. If not, then the same list of investments is presented in step 140.

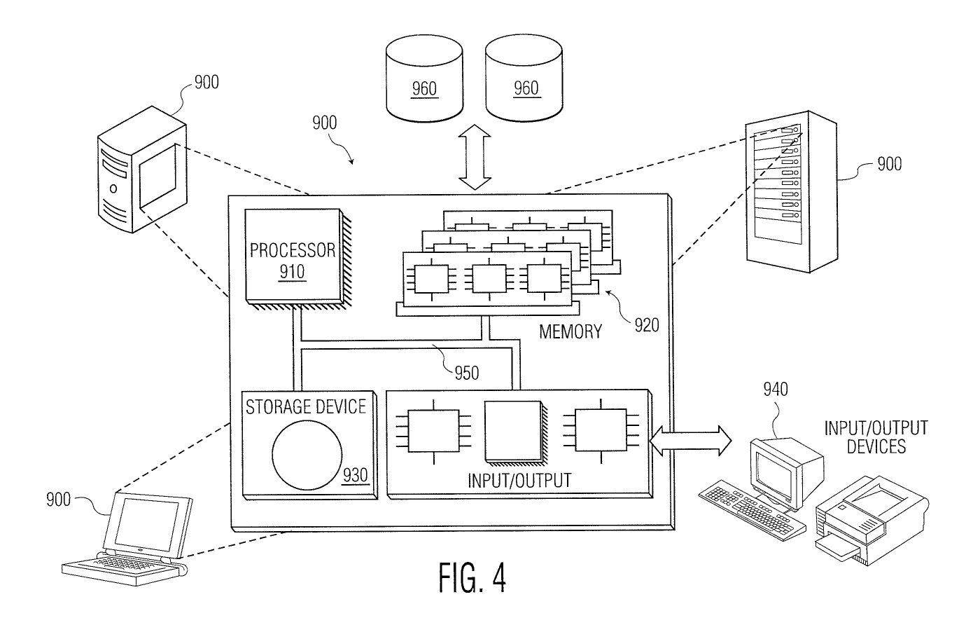

The system is implemented on a computer or server system. FIG. 4 is a diagram displaying a general purpose computer on which the system and method of the present disclosure may be implemented according to an aspect of present disclosure. The computer system 900 may execute at least some of the operations described above. Computer system 900 may include processor 910, memory 920, storage device 930, and input/output devices 940. Some or all of the components 910, 920, 930, and 940 may be interconnected via system bus 950. Processor 910 may be single or multi-threaded and may have one or more cores. Processor 910 may execute instructions, such as those stored in memory 920 or in storage device 930. Information may be received and output using one or more input/output devices 940.

Memory 920 may store information and may be a computer-readable medium, such as volatile or non-volatile memory. Storage device 930 may provide storage for system 900 and may be a computer-readable medium. In various aspects, storage device 930 may be a flash memory device, a floppy disk device, a hard disk device, an optical disk device, or a tape device.

Input/output devices 940 may provide input/output operations for system 900. Input/output devices 940 may include a keyboard, pointing device, and microphone. Input/output devices 940 may further include a display unit for displaying graphical user interfaces, speaker, and printer. External data, such as financial data, may be stored in accessible external databases 960.

The features described may be implemented in digital electronic circuitry, or in computer hardware, firmware, software, or in combinations thereof. The apparatus may be implemented in a computer program product tangibly embodied in an information carrier, e.g., in a machine-readable storage device or in a propagated signal, for execution by a programmable processor; and method steps may be performed by a programmable processor executing a program of instructions to perform functions of the described implementations by operating on input data and generating output.

The described features may be implemented in one or more computer programs that are executable on a programmable system including at least one programmable processor coupled to receive data and instructions from, and to transmit data and instructions to, a data storage system, at least one input device, and at least one output device. A computer program may include set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors of any kind of computer. Generally, a processor may receive instructions and data from a read only memory or a random access memory or both. Such a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable, disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks may include, e.g., a LAN, a WAN, and the computers and networks forming the Internet.

The computer system may include clients and servers. A client and server may be remote from each other and interact through a network, such as the described one. The relationship of client and server may arise by virtue of computer programs running on the respective computers and having a client-server relationship to each other.

At this point, while we have discussed and described the disclosure using some specific examples, those skilled in the art will recognize that our teachings are not so limited. Accordingly, the disclosure should be only limited by the scope of the claims attached hereto.

1. An investment management system comprising one or more servers comprising
a. an investor database comprising investor information;
b. an investment target database comprising company information;
c. machine executable instructions and a user interface for creating and storing investment proposals, the proposals comprising proposed investor identification information, proposed investment target information, and information corresponding to at least one term of the proposed investment; and
d. machine executable instructions for combining two or more investment proposals into an aggregate investment offer.

2. The investment management system of claim 1, the one or more servers further comprising machine executable instructions whereby an investment target can input at least one acceptable term and determine how much money is available for investment, the determination of how much money is available for investment comprising the step of comparing the acceptable term to the at least one term of investment of at least one investment proposal.

3. The investment management system of claim 1, the one or more servers further comprising machine executable instructions for at least one function from the group consisting of: awarding and displaying badges, assigning levels to investors, assigning status to investors.

4. The investment management system of claim 1, the one or more servers further comprising machine executable instructions for reporting historical investments.

5. The investment management system of claim 1, the one or more servers further comprising machine executable instructions for grouping a plurality of investment proposals together on the basis of the investment proposals having a common investment target company and compatible terms.

6. The investment management system of claim 5, the one or more servers further comprising machine executable instructions for notifying a user who creates an investment proposal that other compatible investment proposals have been created.
